(19) United States
(12) Patent Application Publication
(10) Pub. No.: US 2010/0079911 A1
(43) Pub. Date: Apr. 1, 2010

(54) MAGNETIC RECORDING MEDIUM, PROCESS FOR PRODUCING SAME, AND MAGNETIC RECORDING REPRODUCING APPARATUS USING THE MAGNETIC RECORDING MEDIUM

(75) Inventors: Ryuji Sakaguchi, Ichihara-shi (JP); Gouhei Kurokawa, Ichihara-shi (JP); Yuzo Sasaki, Ichihara-shi (JP); Tatsu Komatsuda, Ichihara-shi (JP); Amarendra Singh, Ichihara-shi (JP)

Correspondence Address: SUGHRUE MION, PLLC, 2100 PENNSYLVANIA AVENUE, N.W., SUITE 800, WASHINGTON, DC, 20037, US

(73) Assignee: SHOWA DENKO K.K., Minato-ku, Tokyo (JP)

(21) Appl. No.: 12/597,699

(22) PCT Filed: Apr. 28, 2008
(86) PCT No.: PCT/JP2008/058172

§ 371 Date: Nov. 25, 2009

(30) Foreign Application Priority Data
Apr. 27, 2007 (JP) 2007-119008

(51) Int. Cl. G11B 5/127; G11B 5/66; G11B 5/667; B05D 5/12

(52) U.S. Cl. 360/110; 428/831; 428/828; 428/829; 427/131; G9B/5.04; G9B/5.241

(57) ABSTRACT

A perpendicular magnetic recording medium is provided, which has a backing layer, a primer layer, an intermediate layer and at least one perpendicular magnetic recording layer, and is characterized in that the perpendicular magnetic recording layer contains Co and Cr, and at least one of the perpendicular magnetic recording layer or layers has a granular structure comprising ferromagnetic crystal grains and grain boundaries comprised of non-magnetic tungsten oxide. The perpendicular magnetic recording layer may be a double-layered structure comprising the tungsten oxide grain boundary-containing layer and a Cr oxide, Si oxide, Ta oxide or Ti oxide grain boundary-containing layer formed on the tungsten oxide grain boundary-containing layer. The perpendicular magnetic recording medium exhibits good perpendicular orientation and has ferromagnetic crystal grains with extremely small grain size, and thus, is superior in high recording density characteristic.

### TECHNICAL FIELD

This invention relates to a magnetic recording medium, a process for producing the magnetic recording medium, and a magnetic recording reproducing apparatus using the magnetic recording medium.

### BACKGROUND ART

In recent years, magnetic recording apparatuses such as a magnetic disk apparatus, a flexible disk apparatus and a magnetic tape apparatus are widely used and their importance is increasing. Recording density of a magnetic recording medium used in the magnetic recording apparatuses is greatly enhanced. Especially, since the development of MR head and PRML technique, the plane recording density is more and more increasing. Recently GMR head and TuMR head have been developed, and the rate of increase in the plane recording density is about 100% per year.

There is still increasing a demand for further enhancing the recording density in magnetic recording media, and therefore, a magnetic layer having a higher coercive force and a higher signal-to-noise ratio (S/N ratio), and a high resolution are eagerly desired.

In longitudinal magnetic recording media heretofore widely used, a self-demagnetization effect becomes significantly manifested, that is, adjacent magnetic domains in magnetic transition regions exhibit a function of counteracting the magnetization each other with an increase in a line recording density. To minimize the self-demagnetization effect, thickness of the magnetic recording layer must be reduced to enhance the shape magnetic anisotropy.

However, with a decrease in thickness of the magnetic recording layer, the magnitude of energy barrier for keeping the magnetic domains approximates to the magnitude of heat energy, and consequently, the heat fluctuation occurs, i.e., the recorded magnetization is reduced by the influence of the temperature. This undesirable phenomenon puts an upper limit on the line recordation density.

Recently, an anti-ferromagnetic coupling (AFC) medium has been proposed as means for solving the problem of limitation in the line magnetic recording density in the longitudinal magnetic recording media, which problem arises due to the alleviation of magnetization upon heating.

Perpendicular magnetic recording media attract widespread attention as means for enhancing the plane magnetic recording density. The perpendicular magnetic recording media are characterized in that the magnetization occurs in a direction perpendicular to the major surface of the magnetic recording media, which is in a contrast to the transitional longitudinal magnetic recording media wherein the magnetization occurs in an in-plane direction. Due to this characteristic, the undesirable magnetization-counteracting function as encountered as an obstacle for enhancing the line recording density in the longitudinal magnetic recording media can be avoided, and the magnetic recording density can be more enhanced. Further, the thickness of magnetic recording layer can be maintained at a certain level, and thus, the problem of alleviation of magnetization upon heating as encountered in the traditional longitudinal magnetic recording media can be minimized.

In the manufacture of perpendicular magnetic recording media, a primer layer, an intermediate layer, a magnetic recording layer and a protective layer are usually formed in this order on a non-magnetic substrate. Further, a lubricating layer is often formed on the uppermost protective layer. In many recording media, a magnetic layer called as a soft magnetic backing layer is formed under the primer layer. The primer layer and the intermediate layer are formed for the purpose of improving the characteristics of the magnetic recording layer, more specifically, for providing desired crystal orientation and controlling the shape of magnetic crystals.

To produce perpendicular magnetic recording media having a high recording density characteristic, the crystalline structure of the magnetic recording layer, the discretion of crystal grains and the refinement of grain diameter are important. In perpendicular magnetic recording media, the crystalline structure in the magnetic recording layer is often a hexagonal close-packed (hcp) structure. In this crystalline structure, the (002) crystal face is parallel to the substrate surface, that is, the crystalline c-axes (i.e., [002] axes) are arranged in the perpendicular direction with minimized disturbance, and thus, the intensity of a signal given in the perpendicular direction increases. Further, when crystal grains in the magnetic recording layer become more discrete and the exchange coupling is interrupted, a noise at reproduction from the high density recording can be minimized.

As material for the magnetic recording layer, alloy targets such as, for example, CoCrPt, which have been combined with silicon oxide and/or titanium oxide, have been used (see, for example, patent document 1). The magnetic recording layer comprised of such alloy target has a granular structure wherein CoCrPt crystal grains having a hcp structure are surrounded by grain boundaries comprised of non-magnetic silicon oxide and/or titanium oxide. In this granular structure, good crystalline orientation and good refinement and discretion of crystal grains can be achieved. Silicon and titanium incorporated in the cobalt magnetic material as grain boundary material exhibit a larger free energy change at oxidation than cobalt magnetic material, and therefore, oxides of these elements suppress the undesirable oxidation of cobalt (i.e., prevent or minimize the deterioration of magnetic property) (see, for example, patent document 2).

Therefore silicon oxide and titanium oxide have a function of suppressing oxidation of cobalt and thus preventing the reduction of the magnetic moment. However, silicon oxide and titanium oxide, incorporated in CoCrPt grains, exert an undesirable influence on the orientation of the magnetic crystal grains and the discretion of magnetic crystal grains, with the result of increase in noise.

Thus, in order to provide a magnetic recording medium having more improved recording and reproducing characteristics, it is eagerly desired that discretion of magnetic crystal grains and refinement of crystal grain diameter, and perpendicular orientation are more enhanced. Further, a process for easily producing such a perpendicular magnetic recording medium is also desired.

Patent document 1: JP 2004-327006 A

Patent document 2: JP 2006-164440 A

### DISCLOSURE OF THE INVENTION

### Problems to be Solved by the Invention

In view of the foregoing background art, an object of the present invention is to provide a magnetic recording medium characterized as exhibiting enhanced discretion of magnetic crystal grains and refinement of crystal grain diameter, as well as good perpendicular orientation, and thus, characterized as being capable of recording and reproducing information with high density.

Another object of the present invention is to provide a process for producing the magnetic recording medium having the above-mentioned beneficial characteristics.

A further object of the present invention is to provide a magnetic recording reproducing apparatus provided with a magnetic recording medium having the above-mentioned beneficial characteristics, and a magnetic head for recording and reproducing an information in the magnetic recording medium.

### Means for Solving the Problems

To achieve the above-mentioned objects, the present invention provides the following magnetic recording medium, the following process for producing the magnetic recording medium, and the following magnetic recording reproducing apparatus.

(1). A magnetic recording medium having a backing layer, a primer layer, an intermediate layer and at least one perpendicular magnetic recording layer, characterized in that said perpendicular magnetic recording layer contains Co and Cr, and at least one of the perpendicular magnetic recording layer or layers has a granular structure comprising ferromagnetic crystal grains and grain boundaries comprised of non-magnetic oxide comprising tungsten oxide.

(2). The magnetic recording medium as mentioned above in (1), wherein the perpendicular magnetic recording layer having the granular structure contains 2% to 20% by mole of tungsten oxide.

(3). The magnetic recording medium as mentioned above in (1) or (2), wherein the perpendicular magnetic recording layer having the granular structure contains 2% to 20% by mole of WO₃ as the tungsten oxide.

(4). The magnetic recording medium as mentioned above in (1) or (2), wherein the perpendicular magnetic recording layer having the granular structure contains 2% to 20% by mole of WO₂ as the tungsten oxide.

(5). The magnetic recording medium as mentioned above in any one of (1) to (4), wherein the ferromagnetic crystal grains in the perpendicular magnetic recording layer have an average grain diameter in the range of 3 nm to 10 nm.

(6). The magnetic recording medium as mentioned above in any one of (1) to (5), wherein said perpendicular magnetic recording layer has a thickness in the range of 1 nm to 50 nm.

(7). The magnetic recording medium as mentioned above in any one of (1) to (6), wherein the crystal grains in the perpendicular magnetic recording layer are comprised of a CoCrPt alloy or a CoCrPtB alloy.

(8). The magnetic recording medium as mentioned above in any one of (1) to (7), wherein the backing layer has a soft magnetic non-crystalline structure.

(9). The magnetic recording medium as mentioned above in any one of (1) to (8), wherein said perpendicular magnetic recording medium further has an additional perpendicular magnetic recording layer, formed on said perpendicular magnetic recording layer having a granular structure comprising ferromagnetic crystal grains and grain boundaries comprised of non-magnetic oxide comprising tungsten oxide,

wherein said additional perpendicular magnetic recording layer has a granular structure comprising ferromagnetic crystal grains and grain boundaries comprised of non-magnetic oxide comprising chromium oxide.

(10). The magnetic recording medium as mentioned above in any one of (1) to (8), wherein said perpendicular magnetic recording medium further has an additional perpendicular magnetic recording layer, formed on said perpendicular magnetic recording layer having a granular structure comprising ferromagnetic crystal grains and grain boundaries comprised of non-magnetic oxide comprising tungsten oxide,

wherein said additional perpendicular magnetic recording layer has a granular structure comprising ferromagnetic crystal grains and grain boundaries comprised of non-magnetic oxide comprising silicon oxide.

(11). The magnetic recording medium as mentioned above in any one of (1) to (8), wherein said perpendicular magnetic recording medium further has an additional perpendicular magnetic recording layer, formed on said perpendicular magnetic recording layer having a granular structure comprising ferromagnetic crystal grains and grain boundaries comprised of non-magnetic oxide comprising tungsten oxide,

wherein said additional perpendicular magnetic recording layer has a granular structure comprising ferromagnetic crystal grains and grain boundaries comprised of non-magnetic oxide comprising tantalum oxide.

(12) . The magnetic recording medium as mentioned above in any one of (1) to (8), wherein said perpendicular magnetic recording medium further has an additional perpendicular magnetic recording layer, formed on said perpendicular magnetic recording layer having a granular structure comprising ferromagnetic crystal grains and grain boundaries comprised of non-magnetic oxide comprising tungsten oxide,

wherein said additional perpendicular magnetic recording layer has a granular structure comprising ferromagnetic crystal grains and grain boundaries comprised of non-magnetic oxide comprising titanium oxide.

(13). A process for producing a perpendicular magnetic recording medium comprising forming, on a non-magnetic substrate, a backing layer, a primer layer, an intermediate layer and at least one perpendicular magnetic recording layer, in this order,

characterized in that, as at least one of the perpendicular magnetic recording layer or layers, a perpendicular magnetic recording layer having a granular structure comprising ferromagnetic crystal grains and grain boundaries comprised of non-magnetic oxide comprising tungsten oxide is formed.

(14). A process for producing a perpendicular magnetic recording medium comprising forming, on a non-magnetic substrate, a backing layer, a primer layer, an intermediate layer and at least one perpendicular magnetic recording layer, in this order,

characterized in that, as said perpendicular magnetic recording layer, a perpendicular magnetic recording layer having a granular structure comprising ferromagnetic crystal grains and grain boundaries comprised of non-magnetic oxide comprising tungsten oxide is formed; and further, an additional perpendicular magnetic recording layer is formed on the perpendicular magnetic recording layer having a granular structure comprising ferromagnetic crystal grains and grain boundaries comprised of non-magnetic oxide comprising tungsten oxide; wherein said additional perpendicular magnetic recording layer has a granular structure comprising ferromagnetic crystal grains and grain boundaries comprised of non-magnetic oxide selected from chromium oxide, silicon oxide, tantalum oxide and titanium oxide.

(15). A magnetic recording reproducing apparatus provided with a magnetic recording medium and a magnetic head for recording and reproducing an information in the magnetic recording medium, characterized in that the magnetic recording medium is a magnetic recording medium as mentioned above in any one of (1) to (12).

### EFFECT OF THE INVENTION

According to the present invention, there is provided a perpendicular magnetic recording medium, which has a perpendicular magnetic recording layer wherein the crystal c-axis in a hcp structure is oriented perpendicularly to the surface of substrate with a minimized angle variation, and the ferromagnetic crystal grains constituting the perpendicular magnetic recording layer have an extremely small average grain diameter, and which exhibits highly enhanced recording density characteristic.

### BRIEF DESCRIPTION OF THE DRAWINGS

FIG. 1 is a cross-section illustrating one example of a perpendicular magnetic recording medium according to the present invention.

FIG. 2 is a schematic illustration of an example of the magnetic recording-reproducing apparatus of the present invention.

### REFERENCE NUMERALS

1 Non-magnetic substrate
2 Soft magnetic backing layer
3 Primer layer
4 Intermediate layer
5 Perpendicular magnetic recording layer
6 Protective layer
10 Magnetic recording medium
11 Medium-driving part
12 Magnetic head
13 Head driving part
14 Recording-reproducing signal system

### BEST MODE FOR CARRYING OUT THE INVENTION

The invention will now be described more specifically.

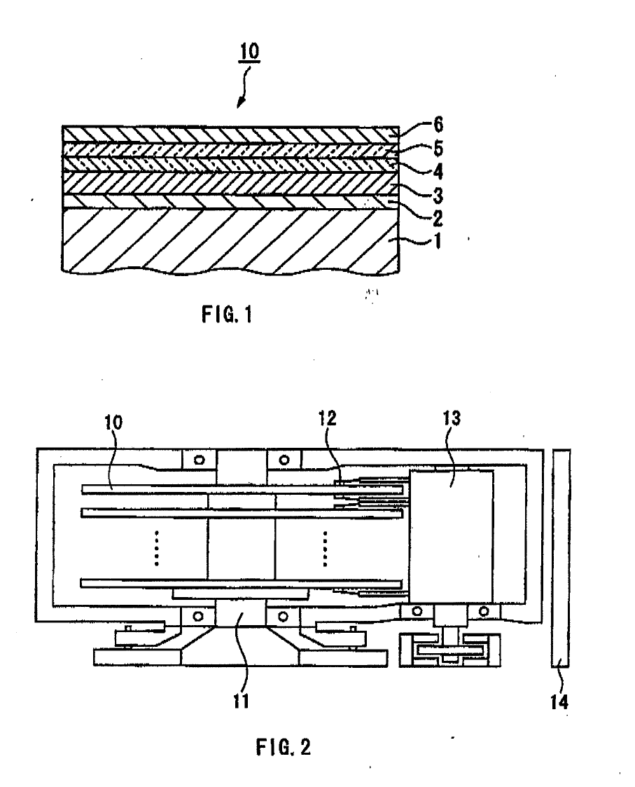

As illustrated in FIG. 1, the perpendicular magnetic recording medium 10 according to the present invention has a multilayer structure having a soft magnetic backing layer 2; a primer layer 3 which constitutes an orientation-controlling layer having a function of controlling orientation of a layer formed thereon; an intermediate layer 4; and at least one perpendicular magnetic recording layer 5, wherein the axis of easy magnetization (i.e., crystal c-axis) is orientated in a direction approximately perpendicular to the surface of substrate 1; and an optional protective layer 6; which are formed in this order on the substrate 1. At least one of the perpendicular magnetic recording layer or layers has a granular structure comprising ferromagnetic crystal grains and grain boundaries comprised of non-magnetic tungsten oxide.

The non-magnetic substrate used in the present invention is not particularly limited provided that it is comprised of a non-magnetic material, and, as specific examples thereof, there can be mentioned aluminum alloy substrates predominantly comprised of aluminum such as, for example, an Al—Mg alloy substrate; and substrates made of ordinary soda glass, aluminosilicate glass, amorphous glass, silicon, titanium, ceramics, sapphire, quartz and resins. Of these, aluminum alloy substrates and glass substrates such as crystallized glass substrates and amorphous glass substrate are widely used. As the glass substrates, mirror polished glass substrates and low surface roughness (Ra) glass substrates (having Ra <1 angstrom) are preferably used. The substrates may be textured to some extent.

In the process for producing the magnetic recording medium, the substrate is usually washed and then dried. That is, the substrates are washed and then dried for assuring sufficient interlayer adhesion. The washing can be conducted with water. Etching (i.e., reverse sputtering) may also be adopted for washing. The size of the substrates is not particularly limited.

The respective layers of the magnetic recording medium will be explained.

The soft magnetic backing layer is comprised of a material having a soft magnetic property, and is widely provided in perpendicular magnetic recording media. The soft magnetic backing layer has a function of, when a signal is recorded in the medium, conducting recording magnetic field from a head and imposing a perpendicular magnetic recording field to the magnetic recording layer with enhanced efficiency.

The material for the soft magnetic backing layer is not particularly limited provided it has a soft magnetic property, and, as specific examples thereof, there can be mentioned FeCo alloys, CoZrNb alloys and CoTaZr alloys. The soft magnetic backing layer preferably has an amorphous structure because the increase in surface roughness (Ra) is prevented and lift-up of a head is minimized, thereby more improving the recording density characteristics.

The soft magnetic backing layer may be either a single layer or a multi-layer comprised of two or more layers. One example thereof has a multi-layer structure wherein an extremely thin film of non-magnetic material such as Ru is sandwiched between two soft magnetic layers, i.e., an anti-ferromagnetically coupled (AFC) layer with a Ru spacer layer.

The total thickness of the soft magnetic backing layer is appropriately determined depending upon the balance between the recording/reproducing characteristics of the magnetic recording layer and the OW characteristics thereof, but the thickness is usually in the range of 20 nm to 120 nm.

An orientation control layer having a function of controlling the orientation of the magnetic recording layer is formed on the soft magnetic backing layer in the perpendicular recording medium of the invention. The orientation control layer has a multi-layer structure which comprises a primer layer, and an intermediate layer, formed on the primer layer.

The primer layer is comprised of, for example, tantalum, or nickel or nickel alloys capable of being oriented in the fcc(111) crystal face, such as, for example, Ni—Nb, Ni—Ta, Ni—V and Ni—W. Even in the case when the soft magnetic backing layer has an amorphous structure, the surface roughness (Ra) is sometimes increased depending upon the material for the soft magnetic backing layer, and the layer-forming conditions, and therefore, a non-magnetic amorphous layer can be formed between the primer layer and the orientation control layer to reduce Ra and improve the orientation of the magnetic recording layer.

The intermediate layer formed on the primer layer is comprised of a material preferably having a hcp structure in a manner similar to the magnetic recording layer, which material is usually selected from Ru and Re, and their alloys. The intermediate layer is provided for the purpose of controlling the orientation of the magnetic recording layer, and therefore, even if the material does not have a hcp structure, it can be used provided that it is capable of controlling the orientation of the magnetic recording layer.

At least one perpendicular magnetic recoding layer (“perpendicular magnetic recording layer” is hereinafter abbreviated to “magnetic recording layer” when appropriate) in the magnetic recording medium according to the invention has a granular structure. Therefore, the intermediate layer preferably has a rough surface, which is obtained by conducting the formation of intermediate layer at a high gas pressure. However, adoption of too high gas pressure leads to deterioration of crystalline orientation of the intermediate layer and sometimes leads to the intermediate layer having a too high surface roughness. Therefore, to satisfy both of the crystalline orientation and the surface roughness, the optimal gas pressure should be chosen, or a double-layered intermediate layer comprising a layer formed at a low gas pressure and a layer formed at a high gas pressure should be provided.

The magnetic recording layer is provided for recording a signal thereon.

The magnetic recording medium is characterized in that at least one of the perpendicular magnetic recording layer or layers has a granular structure comprising ferromagnetic crystal grains and grain boundaries comprised of non-magnetic oxide comprising tungsten oxide.

The ferromagnetic material in the magnetic recording layer is alloys comprising cobalt and chromium as essential ingredients, and, as specific examples thereof, there can be mentioned cobalt alloys such as CoCr, CoCrPt and CoCrPtB. Of these, CoCrPt and CoCrPtB are preferably used.

Ferromagnetic crystal grains of the magnetic material preferably have an average grain diameter in the range of 3 nm to 10 nm. The average grain diameter can be measured on the cross-sectional TEM image.

The granular structure comprises grain boundaries comprised of non-magnetic oxide comprising tungsten oxide such as WO₃ and WO₂. The tungsten oxide preferably includes WO₃ and WO₂. The amount of tungsten oxide such as WO₃ and WO₂ in the tungsten oxide-containing magnetic recording layer is preferably in the range of 2% to 20% by mole. The tungsten oxide-containing magnetic recording layer preferably has a thickness in the range of 1 nm to 50 nm.

The magnetic recording layer in the perpendicular magnetic recording medium of the invention may be a double-layered structure comprising a first magnetic recording layer and a second magnetic recording layer. The ferromagnetic materials in the two magnetic recording layers may be the same or different.

Preferably, the perpendicular magnetic recording medium has a first magnetic recording layer having a granular structure comprising ferromagnetic crystal grains and grain boundaries comprised of non-magnetic tungsten oxide, and a second magnetic recording layer, formed on the first magnetic recording layer, having a granular structure comprising ferromagnetic crystal grains and grain boundaries comprised of other oxide. The oxide used in the second magnetic recording layer is preferably at least one selected from chromium oxide, silicon oxide, tantalum oxide and titanium oxide.

Tungsten is not easily oxidized as compared with elements which have been conventionally used in oxide-containing magnetic recording materials, such as silicon and titanium, and there is no great difference in the variation of free energy due to oxidation between cobalt and tungsten, and therefore, at the formation of the magnetic recording layer, oxidation tends to occur in not only tungsten but also cobalt, leading to reduction of magnetic moment. For this reason, tungsten has heretofore not been used for the incorporation in the cobalt magnetic material.

It is, however, to be noted that, when a magnetic material comprised of cobalt and chromium, such as CoCrPt or CoCrPtB, especially an alloy containing certain proportion of chromium and cobalt, is used in the co-presence of tungsten, chromium is oxidized more easily than cobalt, and thus, the undesirable reduction in signal intensity due to the oxidation of cobalt can be substantially avoided. X-ray photoelectron spectroscopic analysis (XPS) of the cobalt-chromium-containing magnetic recording layer revealed that, when silicon or titanium is incorporated according to the present invention, there is no great difference between the state of cobalt and that of chromium. In contrast, when tungsten is incorporated, chromium oxide is produced in a larger amount than cobalt oxide in the magnetic recording layer.

In a perpendicular magnetic recording layer having a granular structure, the width of grain boundaries surrounding magnetic crystal grains and the size of magnetic crystal grains vary, and thus, the recording-reproducing characteristics vary, depending upon the particular kind of oxides constituting the grain boundaries. In the case when an oxide present in the granular structure is not easily subject to segregation from the magnetic grain grains, the oxide tends to remain within the magnetic crystal grains, which gives a baneful influence on the crystalline orientation and leads to deterioration of the magnetic properties.

It can be evaluated by the half value width Δ(delta)θ50 of a rocking curve whether the crystalline c-axis ([002] axis) in the magnetic recording layer is arranged in perpendicular to the substrate surface of the crystals with minimized disturbance, or not. The half value width Δθ50 of a rocking curve is determined as follows. A magnetic recording layer formed on the substrate is analyzed by X-ray diffractometry, i.e., the crystal face which is parallel to the substrate surface is analyzed by scanning the incident angle of X-ray to observe diffraction peaks corresponding to the crystal face. In the perpendicular magnetic recording medium comprising a cobalt alloy magnetic material, crystalline orientation occurs so that the direction of the c-axis [002] of the hcp structure is perpendicular to the substrate surface, peaks attributed to the (002) crystal face are observed. Then the optical system is swung relative to the substrate surface while a Bragg angle diffracting the (002) crystal face is maintained. The diffraction intensity of the (002) crystal face relative to the angle at which the optical system is inclined is plotted to draw a rocking curve with a center at a swung angle of zero degree. If the (002) crystal faces are in parallel with the substrate surface, a rocking curve with a sharp shape is obtained. In contrast, if the (002) crystal faces are broadly distributed, a rocking curve with a broadly widened shape is obtained. Thus, the crystalline orientation in the perpendicular magnetic recording medium can be evaluated on the basis of the half value width Δ(delta)θ50 of the rocking curve.

In the magnetic recording layer of the magnetic recording medium according to the present invention has a granular structure comprising ferromagnetic crystal grains and grain boundaries comprised of tungsten oxide, the magnetic crystal grains are smaller and the half value width Δθ50 of the magnetic recording layer is smaller than those of the conventional magnetic recording layer containing only silicon oxide or titanium oxide.

The respective layers in the perpendicular magnetic recording medium according to the present invention are usually formed by a DC magnetron sputtering method or an RF sputtering method. Imposition of RF bias, DC bias, pulse DC or pulse DC bias can be adopted for sputtering. An inert gas such as, for example, argon can be used as sputtering gas, to which O₂ gas, H₂O or N₂ gas may be added. The pressure of sputtering gas is appropriately chosen for the respective layers so as to give layers with the desired characteristics, but, the pressure is usually in the range of approximately 0.1 to 30 Pa. An appropriate pressure can be determined depending upon the particular magnetic characteristics of magnetic recording medium.

A protective layer is provided so as to protect the magnetic recording medium from being damaged by the contact thereof with ahead. The protective layer includes, for example, a carbon layer and a SiO₂ layer. A carbon layer is widely used. The protective layer can be formed by, for example, a sputtering method or a plasma CVD method. A plasma CVD method including a magnetron plasma CVD method is popularly used in recent years.

The thickness of protective layer is usually in the range of 1 nm to 10 nm, preferably 2 nm to 6 nm and more preferably 2 nm to 4 nm.

The constitution of an example of the magnetic recording-reproducing apparatus according to the present invention is illustrated in FIG. 2. The magnetic recording-reproducing apparatus of the present invention comprises, in combination, the magnetic recording medium 10; a driving part 11 for driving the magnetic recording medium in the circumferential recording direction; a magnetic head 12 for recording an information on the magnetic recording medium 10 and reproducing the information from the medium 10; a head-driving part 13 for moving the magnetic head 12 in a relative motion to the magnetic recording medium 10; and a recording-and-reproducing signal treating means 14. The recording-and-reproducing signal treating means 14 has a function of transmitting signal from the outside to the magnetic head 12, and transmitting the reproduced output signal from the magnetic head 12 to the outside.

As the magnetic head 12 provided in the magnetic recording reproducing apparatus according to the present invention, there can be used a magnetic head provided with a reproduction element suitable for high-magnetic recording density, which includes a magneto-resistance (MR) element exhibiting anisotropic magnetic resistance (AMR) effect, a GMR element exhibiting giant magneto-resistance (GMR) effect and a TuMR element exhibiting a tunneling magneto-resistance effect.

### EXAMPLES

The invention will now be described specifically by the following examples.

### Example 1

### Comparative Example 1

### Production of Perpendicular Magnetic Mediums, and Evaluation of Magnetic Characteristics

A glass substrate for HD was placed in a vacuum chamber and the chamber was evacuated to a reduced pressure of below 1.0×10⁻⁵ Pa. A soft magnetic backing layer comprised of CoNbZr and having a thickness of 50 nm was formed on the glass substrate, and then a primer layer comprised of NiFe with a fcc structure and having a thickness of 5 nm was formed. The formation of the backing layer and the primer layer was carried out by a sputtering method at a reduced pressure of 0.6 Pa in an argon atmosphere. An intermediate layer comprised of Ru was formed on the primer layer by a sputtering method in an argon atmosphere in two stages, that is, a Ru layer with a thickness of 10 nm was formed at a reduced pressure of 0.6 Pa in a first stage, and further a Ru layer with a thickness of 10 nm was formed at a reduced pressure of 10 Pa in a second stage.

A magnetic recording layer with a thickness of 10 nm was formed on the intermediate layer at a reduced pressure of 2 Pa in an argon atmosphere.

The compositions of the magnetic recording layers formed in Examples 1-1 and 1-2 were as follows.

Example 1-1, 90(Co15Cr20Pt)−10(WO₃)

Example 1-2, 90(Co13Cr20Pt)−10(WO₂)

Note, the numerals “90” and “10” which occur immediately before the parentheses refer to a proportion by mole % of the respective components. For example, in Example 1-1, the proportions of Co15Cr20Pt and WO₃ are 90% by mole and 10% by mole, respectively. “Co15Cr20Pt” within each parenthesis refers to the composition of alloy which consists of 15% by mole of Co, 20% by mole of Cr and the balance Pt. This expedient expression applies in the following Examples and Comparative Examples.

For comparison, a magnetic recording layer with a thickness of 10 nm was formed on the intermediate layer at a reduced pressure of 2 Pa in an argon atmosphere by substantially the same procedure as mentioned above, except that the composition thereof was changed as follows.

Comparative Example 1-1, 90(Co10Cr20Pt)−10(SiO₂)

Comparative Example 1-2, 90(Co10Cr20Pt)−10(TiO₂)

Comparative Example 1-3, 90(Co10Cr20Pt)−10(Cr₂O₃)

The amount of Cr relative to the amount of Co in the magnetic alloys in Examples 1-1 and 1-2 was larger than that in Comparative Examples 1-1, 1-2 and 1-3. This is for the purpose of suppressing oxidation of cobalt occurring due to the incorporation of tungsten oxide in Examples 1-1 and 1-2.

A thin carbon film as a protective layer was formed on each of the magnetic recording layers in the above examples and comparative examples to give a perpendicular magnetic recording medium.

Each of the perpendicular magnetic recording mediums made in Examples 1-1 and 1-2 and Comparative Examples 1-1, 1-2 and 1-3 was coated with a lubricant, and recording/reproducing characteristics thereof were evaluated using Read-Write Analyzer 1632 and Spin Stand S1701MP, available from GUZIK, US. Further, magnetostatic property of the same perpendicular magnetic recording mediums was evaluated using a Kerr tester. Crystal orientation of the CoCrPt magnetic crystal in each magnetic recording layer was evaluated by rocking curve measurement of the magnetic recording layer using X-ray diffractometry. Crystal grain diameter was measured on a plain TEM image of the magnetic recording layer.

From the measurement results, a high signal-to-noise ratio (SNR), coercive force (Hc), delta θ50 and average grain diameter of CoCrPt magnetic crystal were determined. The results are shown in Table 1. These characteristics are parameters widely used for evaluating the performance of perpendicular magnetic recording mediums.

TABLE 1

| | | | | Average | |
|---|---|---|---|---|---|
| | | | | Grain | |
| | | | | Diam- | Co |
| | | SNR | Hc | eter | [symbol] θ50 |
| Sample | Composition | (dB) | (Oe) | (nm) | (°) |
| Example | 90(Co15Cr20Pt)—10(WO₃) | 15.34 | 4802 | 7.5 | 3.50 |
| 1-1 | | | | | |
| Example | 90(Co13Cr20Pt)—10(WO₂) | 15.22 | 4882 | 7.6 | 3.61 |
| 1-2 | | | | | |
| Comp. Ex. | 90(Co10Cr20Pt)—10(SiO₂) | 14.45 | 4563 | 8.1 | 4.02 |
| 1-1 | | | | | |
| Comp. Ex. | 90(Co10Cr20Pt)—10(TiO₂) | 14.31 | 4620 | 8.2 | 4.11 |
| 1-2 | | | | | |
| Comp. Ex. | 90(Co10Cr20Pt)—10(Cr₂O₃) | 14.33 | 4302 | 7.9 | 4.24 |
| 1-3 | | | | | |

As seen from Table 1, the incorporation of tungsten oxide reduces diameter of magnetic crystal grains and enhances crystalline orientation, which is in contrast to the incorporation of silicon oxide, titanium oxide or chromium oxide. That is, tungsten oxide has a function of improving the magnetostatic characteristics and electromagnetic conversion characteristics to an extent greater than that achieved by silicon oxide, titanium oxide or chromium oxide. It is presumed that this is due to the fact that tungsten oxide exhibits high segregation to grain boundaries as compared with the other oxides. The granular structure of the tungsten oxide-containing magnetic recoding layer was observed by the TEM image.

Evaluation of Saturation Magnetization Ms and Perpendicular Magnetic Anisotropy Ku

For torque measurement, magnetic recording mediums were produced by the same procedures as mentioned in Examples 1-1 and 1-2, and Comparative Examples 1-1, 1-2 and 1-3, wherein a non-magnetic amorphous material Cr50Ti layer with a thickness of 20 nm was formed at a reduced pressure of 0.8 Pa instead of the soft magnetic backing layer. The non-magnetic amorphous material Cr50Ti layer was formed for the torque measurement, which layer is completely free of magnetization in contrast to the soft magnetic backing layer. The primary NiFe layer, the intermediate Ru layer, the magnetic recording layer and the carbon protective layer were formed in this order on the non-magnetic amorphous layer by the same procedures and conditions as adopted in the above-mentioned examples and comparative examples. All procedures and other conditions remained the same.

Using the magnetic recording mediums, saturation magnetization Ms (emu/cm³) and perpendicular magnetic anisotropy Ku (erg/cm³) of each magnetic recording layer were measured by a vibrating sample magnetometer (VSM) measurement and a torque measurement. The test results are shown in Table 2.

TABLE 2

| | | Ms | |
|---|---|---|---|
| Sample | Composition | (emu/cm³) | Ku (erg/cm³) |
| Example 1 | 90(Co15Cr20Pt)—10(WO₃) | 652 | 6.85 |
| Example 2 | 90(Co13Cr20Pt)—10(WO₂) | 661 | 6.71 |
| Comp. Ex. 1 | 90(Co10Cr20Pt)—10(SiO₂) | 673 | 5.45 |
| Comp. Ex. 2 | 90(Co10Cr20Pt)—10(TiO₂) | 689 | 5.65 |
| Comp. Ex. 3 | 90(Co10Cr20Pt)—10(Cr₂O₃) | 669 | 5.42 |

As seen from Table 2, the saturated magnetization of the tungsten oxide-containing magnetic recording layer is only several % less than those of the other oxide-containing magnetic recording layer. Usually the saturated magnetization of a CoCrPt magnetic recording layer varies in direct proportion to the amount of cobalt. The cobalt content in the above-mentioned tungsten oxide-containing magnetic recording layers is not high, and thus, these magnetic recording layers exhibited somewhat low saturated magnetization. It is to be noted that the VSM measurement revealed that incorporation of tungsten oxide in the magnetic recording layer does not causes undesirable oxidation (leading to reduction of magnetization). The incorporation of tungsten oxide exhibited enhanced perpendicular magnetic anisotropy as compared with the other oxides, as is expected from the fact that the incorporation of tungsten oxide exhibited improvement in crystalline orientation and coercive force in Examples 1-1 and 1-2.

### Example 2

### Comparative Example 2

By the same procedures as mentioned in Example 1, perpendicular magnetic recording mediums were produced wherein the magnetic recording layers having the following compositions and having a thickness of 10 nm were formed at a reduced pressure of 2 Pa in an argon atmosphere. The soft magnetic backing layer, the primer layer, the intermediate layer and the uppermost carbon protective layers were formed under the same conditions as mentioned in Example 1.

Example 2-1, 95(Co15Cr20Pt)−5(WO₃)

Example 2-2, 90(Co15Cr20Pt)−10(WO₃)

Example 2-3, 85(Co15Cr20Pt)−15(WO₃)

Example 2-4, 80(Co15Cr20Pt)−20(WO₃)

Example 2-5, 95(Co13Cr20Pt)−5(WO₂)

Example 2-6, 90(Co13Cr20Pt)−10(WO₂)

Example 2-7, 85(Co13Cr20Pt)−15(WO₂)

Example 2-8, 80(Co13Cr20Pt)−20(WO₂)

For comparison, by the same procedures as mentioned in Example 1, perpendicular magnetic recording mediums were produced wherein the magnetic recording layers having the following compositions and having a thickness of 10 nm were formed at a reduced pressure of 2 Pa in an argon atmosphere. All other conditions and procedures remained the same.

Comparative Example 2-1, Co15Cr20Pt

Comparative Example 2-2, Co13Cr20Pt

Using the magnetic recording mediums, high signal to noise ratio (SNR), coercive force (Hc), delta θ50 and average grain diameter of CoCrPt magnetic crystal were determined. The results are shown in Table 3.

TABLE 3

| | | | | Average | |
|---|---|---|---|---|---|
| | | | | Grain | Co |
| | | SNR | Hc | Diameter | [symbol] θ50 |
| Sample | Composition | (dB) | (Oe) | (nm) | (°) |
| Example | 95(Co15Cr20Pt)—5(WO₃) | 15.23 | 4903 | 7.7 | 3.20 |
| 2-1 | | | | | |
| Example | 90(Co15Cr20Pt)—10(WO₃) | 15.65 | 4754 | 7.5 | 3.53 |
| 2-2 | | | | | |
| Example | 85(Co15Cr20Pt)—15(WO₃) | 16.17 | 4588 | 7.1 | 3.62 |
| 2-3 | | | | | |
| Example | 80(Co15Cr20Pt)—20(WO₃) | 15.42 | 4235 | 6.9 | 3.89 |
| 2-4 | | | | | |
| Example | 95(Co13Cr20Pt)—5(WO₂) | 15.17 | 5021 | 7.8 | 3.13 |
| 2-5 | | | | | |
| Example | 90(Co13Cr20Pt)—10(WO₂) | 15.83 | 4784 | 7.6 | 3.59 |
| 2-6 | | | | | |
| Example | 85(Co13Cr20Pt)—15(WO₂) | 16.04 | 4520 | 7.3 | 3.72 |
| 2-7 | | | | | |
| Example | 80(Co13Cr20Pt)—20(WO₂) | 15.39 | 4296 | 6.8 | 3.92 |
| 2-8 | | | | | |
| Comp. Ex. | Co15Cr20Pt | 8.56 | 5201 | 12.6 | 2.99 |
| 2-1 | | | | | |
| Comp. Ex. | Co13Cr20Pt | 6.72 | 5195 | 13.5 | 2.91 |
| 2-2 | | | | | |

As seen from Table 3, the incorporation of tungsten oxide in an amount of 5% to 20% by mole reduces diameter of magnetic crystal grains and enhances crystalline orientation, and thus, the magnetostatic characteristics and electromagnetic conversion characteristics are improved. In contrast, in the case when tungsten oxide was not incorporated (Comparative Examples 2-1 and 2-2), the crystalline orientation is high and the crystal grain diameter is large, and thus, the coercive force is larger than those in Examples 2-1 to 2-8. But, due to the absence of tungsten oxide, the magnetic crystal grains are not completely discrete and thus exhibit exchange coupling with each other. This leads to an increase in noise and the high signal-noise ratio is 5 dB or more large as compared with those in Examples 2-1 to 2-8.

### Example 3

### Comparative Example 3

By the same procedures as mentioned in Example 1, perpendicular magnetic recording mediums were produced wherein the magnetic recording layer was formed in two stages. That is, a first magnetic layer (tungsten oxide-containing magnetic layer) having a thickness of 5 nm, and then a second magnetic layer (SiO₂- or TiO₂-containing magnetic layer) having a thickness of 5 nm were formed at a reduced pressure of 2 Pa in an argon atmosphere. The tungsten-containing magnetic layers and SiO₂- or TiO₂-containing magnetic layers had the following compositions. The soft magnetic backing layer, the primer layer, the intermediate layer and the uppermost carbon protective layers were formed under the same conditions as mentioned in Example 1.

Compositions of first magnetic layer/second magnetic layer:

### Example 3-1, 90(Co15Cr20Pt)−10(WO₃)/90(Co10Cr20Pt)−10(SiO₂)

### Example 3-2, 90(Co15Cr20Pt)−10(WO₃)/90 (Co10Cr20Pt)−10(TiO₂)

### Example 3-3, 90(Co13Cr20Pt)−10(WO₂)/90 (Co10Cr20Pt)−10(SiO₂)

### Example 3-4, 90(Co13Cr20Pt)−10(WO₂)/90 (Co10Cr20Pt)−10(TiO₂)

For comparison, by the same procedures as mentioned in Example 1, perpendicular magnetic recording mediums were produced wherein a single magnetic recording layer having the following composition and having a thickness of 10 nm was formed at a reduced pressure of 2 Pa in an argon atmosphere. All other conditions and procedures remained the same.

Comparative Example 3-1, 90(Co10Cr20Pt)−10(SiO₂)

Comparative Example 3-2, 90(Co10Cr20Pt)−10(TiO₂)

Using the magnetic recording mediums, high signal to noise ratio (SNR), coercive force (Hc), delta θ50 and average grain diameter of CoCrPt magnetic crystal were determined. The results are shown in Table 4.

TABLE 4

| | | | | | Average | |
|---|---|---|---|---|---|---|
| | | Second Magnetic | | | Grain | Co |
| | First Magnetic | Recording | SNR | Hc | Diameter | [symbol] θ50 |
| Sample | Recording Layer | Layer | (dB) | (Oe) | (nm) | (°) |
| Ex. | 90(Co15Cr20Pt)—10(WO₃) | 90(Co10Cr20Pt)—10(SiO₂) | 16.32 | 4679 | 7.5 | 3.55 |
| 3-1 | | | | | | |
| Ex. | 90(Co15Cr20Pt)—10(WO₃) | 90(Co10Cr20Pt)—10(TiO₂) | 16.11 | 4692 | 7.6 | 3.64 |
| 3-2 | | | | | | |
| Ex. | 90(Co13Cr20Pt)—10(WO₂) | 90(Co10Cr20Pt)—10(SiO₂) | 16.20 | 4689 | 7.7 | 3.58 |
| 3-3 | | | | | | |
| Ex. | 90(Co13Cr20Pt)—10(WO₂) | 90(Co10Cr20Pt)—10(TiO₂) | 15.94 | 4723 | 7.6 | 3.67 |
| 3-4 | | | | | | |

| | | | | | |
|---|---|---|---|---|---|
| Comp. | 90(Co10Cr20Pt)—10(SiO₂) | 14.31 | 4654 | 8.1 | 3.92 |
| Ex. | | | | | |
| 3-1 | | | | | |
| Comp. | 90(Co10Cr20Pt)—10(TiO₂) | 14.74 | 4481 | 8.2 | 4.13 |
| Ex. | | | | | |
| 3-2 | | | | | |

As seen from Table 4, in the case when a tungsten oxide-containing first magnetic layer is formed in combination with a tungsten oxide-not-containing second magnetic layer, the diameter of magnetic crystal grains can be reduced and the crystalline orientation is enhanced, and thus, the magnetostatic characteristics and electromagnetic conversion characteristics are improved.

### INDUSTRIAL APPLICABILITY

The perpendicular recording medium according to the present invention is characterized as having a crystalline structure of the magnetic recording layer, more specifically, a hexagonal close-packed (hcp) structure, wherein its crystalline c-axes are arranged in the perpendicular direction with minimized disturbance in angle, and ferromagnetic crystals in the magnetic recording layer have an extremely small average grain diameter. Therefore the perpendicular recording medium exhibits improved recording density characteristics, and is suitable for, for example, a magnetic disk apparatus and a flexible disk apparatus.

The perpendicular magnetic recording medium is expected to have a more enhanced recording density, and is also suitable for new high-density recording media such as, for example, ECC media, discrete track media and pattern media.

1. A magnetic recording medium having a backing layer, a primer layer, an intermediate layer and at least one perpendicular magnetic recording layer, characterized in that said perpendicular magnetic recording layer contains Co and Cr, and at least one of the perpendicular magnetic recording layer or layers has a granular structure comprising ferromagnetic crystal grains and grain boundaries comprised of non-magnetic oxide comprising tungsten oxide.

2. The magnetic recording medium according to claim 1, wherein the perpendicular magnetic recording layer having the granular structure contains 2% to 20% by mole of tungsten oxide.

3. The magnetic recording medium according to claim 1, wherein the perpendicular magnetic recording layer having the granular structure contains 2% to 20% by mole of WO₃ as the tungsten oxide.

4. The magnetic recording medium according to claim 1, wherein the perpendicular magnetic recording layer having the granular structure contains 2% to 20% by mole of WO₂ as the tungsten oxide.

5. The magnetic recording medium according to claim 1, wherein the ferromagnetic crystal grains in the perpendicular magnetic recording layer have an average grain diameter in the range of 3 nm to 10 nm.

6. The magnetic recording medium according to claim 1, wherein said perpendicular magnetic recording layer has a thickness in the range of 1 nm to 50 nm.

7. The magnetic recording medium according to claim 1, wherein the crystal grains in the perpendicular magnetic recording layer are comprised of a CoCrPt alloy or a CoCrPtB alloy.

8. The magnetic recording medium according to claim 1, wherein the backing layer has a soft magnetic non-crystalline structure.

9. The magnetic recording medium according to claim 1, wherein said perpendicular magnetic recording medium further has an additional perpendicular magnetic recording layer, formed on said perpendicular magnetic recording layer having a granular structure comprising ferromagnetic crystal grains and grain boundaries comprised of non-magnetic oxide comprising tungsten oxide,
wherein said additional perpendicular magnetic recording layer has a granular structure comprising ferromagnetic crystal grains and grain boundaries comprised of non-magnetic oxide comprising chromium oxide.

10. The magnetic recording medium according to claim 1, wherein said perpendicular magnetic recording medium further has an additional perpendicular magnetic recording layer, formed on said perpendicular magnetic recording layer having a granular structure comprising ferromagnetic crystal grains and grain boundaries comprised of non-magnetic oxide comprising tungsten oxide,
wherein said additional perpendicular magnetic recording layer has a granular structure comprising ferromagnetic crystal grains and grain boundaries comprised of non-magnetic oxide comprising silicon oxide.

11. The magnetic recording medium according to claim 1, wherein said perpendicular magnetic recording medium further has an additional perpendicular magnetic recording layer, formed on said perpendicular magnetic recording layer having a granular structure comprising ferromagnetic crystal grains and grain boundaries comprised of non-magnetic oxide comprising tungsten oxide,
wherein said additional perpendicular magnetic recording layer has a granular structure comprising ferromagnetic crystal grains and grain boundaries comprised of non-magnetic oxide comprising tantalum oxide.

12. The magnetic recording medium according to claim 1, wherein said perpendicular magnetic recording medium further has an additional perpendicular magnetic recording layer, formed on said perpendicular magnetic recording layer having a granular structure comprising ferromagnetic crystal grains and grain boundaries comprised of non-magnetic oxide comprising tungsten oxide,
wherein said additional perpendicular magnetic recording layer has a granular structure comprising ferromagnetic crystal grains and grain boundaries comprised of non-magnetic oxide comprising titanium oxide.

13. A process for producing a perpendicular magnetic recording medium comprising forming, on a non-magnetic substrate, a backing layer, a primer layer, an intermediate layer and at least one perpendicular magnetic recording layer, in this order,
characterized in that, as at least one of the perpendicular magnetic recording layer or layers, a perpendicular magnetic recording layer having a granular structure comprising ferromagnetic crystal grains and grain boundaries comprised of non-magnetic oxide comprising tungsten oxide is formed.

14. A process for producing a perpendicular magnetic recording medium comprising forming, on a non-magnetic substrate, a backing layer, a primer layer, an intermediate layer and at least one perpendicular magnetic recording layer, in this order,
characterized in that, as said perpendicular magnetic recording layer, a perpendicular magnetic recording layer having a granular structure comprising ferromagnetic crystal grains and grain boundaries comprised of non-magnetic oxide comprising tungsten oxide is formed; and further, an additional perpendicular magnetic recording layer is formed on the perpendicular magnetic recording layer having a granular structure comprising ferromagnetic crystal grains and grain boundaries comprised of non-magnetic oxide comprising tungsten oxide; wherein said additional perpendicular magnetic recording layer has a granular structure comprising ferromagnetic crystal grains and grain boundaries comprised of non-magnetic oxide selected from chromium oxide, silicon oxide, tantalum oxide and titanium oxide.

15. A magnetic recording reproducing apparatus provided with a magnetic recording medium and a magnetic head for recording and reproducing an information in the magnetic recording medium, characterized in that the magnetic recording medium is a magnetic recording medium as claimed in claim 1.
